(19) United States
(12) Patent Application Publication
(10) Pub. No.: US 2009/0130413 A1
(43) Pub. Date: May 21, 2009

(54) THINNED SUBSTRATE, MANUFACTURING PROCESS THEREOF, AND MANUFACTURING PROCESS OF DISPLAY PANEL APPLYING THE SAME

(75) Inventors: Jer-Yao Wu, Hsinchu (TW); Jong-Wen Chwu, Hsinchu (TW); Yu-Chen Liu, Hsinchu (TW); Chao-Cheng Lin, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/018,157

(22) Filed: Jan. 22, 2008

(30) Foreign Application Priority Data
Nov. 21, 2007 (TW) 96144113

(51) Int. Cl. B32B 7/00; G02B 5/00; B32B 37/00

(52) U.S. Cl. 428/220; 156/60

(57) ABSTRACT

A thinned substrate for a display panel and manufacturing process thereof are provided. The thinned substrate includes an inorganic transparent plate and a supporting layer to form a stacked layer. The supporting layer avails improvement of structure strength of the thinned substrate and reliability of the thinned substrate. A ratio between thickness of the inorganic transparent plate and thickness of the supporting layer is substantially less than or substantially equal to 4. A total thickness of the stacked layer is substantially less than or substantially equal to 20 mm. Bending strength of the stacked layer is substantially greater than or substantially equal to 150 MPa. Besides, a manufacturing process of the display panel applying said thinned substrate is also provided.

### CROSS-REFERENCE TO RELATED APPLICATION

This application claims the priority benefit of Taiwan application serial no. 96144113, filed on Nov. 21, 2007. The entirety of the above-mentioned patent application is hereby incorporated by reference herein and made a part of this specification.

### BACKGROUND OF THE INVENTION

1. Field of the Invention

The present invention relates to a substrate, a manufacturing process and application thereof. More particularly, the present invention relates to a thinned substrate used for a display panel, a manufacturing process thereof and a manufacturing process of a display panel applying the same.

2. Description of Related Art

Presently, flat panel displays (such as liquid crystal flat panel displays, organic light emitting displays (OLEDs), plasma displays etc.) have been widely applied to consumable electronic products or computer products such as medium and small portable televisions (TVs), cell phones, video cameras, notebook computers, desktop displays and projection TVs etc. However, demanding by the market, screen of the flat panel display has a general trend of big sized and light-weighted.

In a conventional technique, weight and thickness of a flat panel display may be reduced by thinning a substrate thereof. However, bending strength of the thinned substrate is also reduced, and reliability of the substrate is reduced. Accordingly, especially if the substrate is a large-sized substrate, reliability of the substrate is much lower. Therefore, during manufacturing process of the display panel, production yield may be reduced due to damage of display panel caused by external forces during transportation. Thus, how to improve the bending strength of the thinned substrate becomes a major subject to be solved in manufacturing technique of the display panel.

### SUMMARY OF THE INVENTION

The present invention is directed to a thinned substrate for a display panel, in which the thinned substrate has a relatively high reliability, and is suitable for follow-up processing.

The present invention is directed to a method for fabricating a substrate of a display panel, by which the substrate with a relatively high reliability may be obtained.

The present invention is directed to a method for fabricating a display panel using the aforementioned thinned substrate, which may have a relatively high production yield.

The present invention provides a thinned substrate for a display panel. The thinned substrate includes an inorganic transparent plate and a supporting layer, wherein the supporting layer and the inorganic transparent plate are stacked to form a stacked layer. A ratio between thickness of the inorganic transparent plate and the thickness of the supporting layer is substantially less than or substantially equal to 4, and is substantially greater than 0. A total thickness of the stacked layer is substantially less than or substantially equal to 20 mm, and bending strength of the stacked layer is substantially greater than or substantially equal to 150 MPa.

The present invention provides a method for fabricating a substrate of a display panel. First, a thinned inorganic transparent plate including a plurality of display devices is provided. Next, a supporting layer is provided to the thinned inorganic transparent plate, such that the supporting layer and the thinned inorganic transparent plate may form a stacked layer. Wherein, the supporting layer and the display devices are respectively disposed at two opposite sides of the inorganic transparent plate, and a ratio between thickness of the thinned inorganic transparent plate and the thickness of the supporting layer is substantially less than or substantially equal to 4, and is substantially greater than 0. Moreover, a total thickness of the thinned inorganic transparent plate and the supporting layer is substantially less than or substantially equal to 20 mm. Bending strength of the stacked layer is substantially greater than or substantially equal to 150 MPa.

The present invention provides a method for fabricating a display panel. First, a thinned first inorganic transparent plate including a plurality of first display devices is provided. Next, a first supporting layer is provided to the thinned first inorganic transparent plate to form a first substrate. Wherein, the supporting layer and the thinned first inorganic transparent plate form a first stacked layer, and the first supporting layer and the first display devices are respectively disposed at two opposite sides of the thinned first inorganic transparent plate. Next, a second substrate is provided, and a cell process is performed to the first substrate and the second substrate to form a display panel array composed of a plurality of display panel units. Wherein, the second substrate and the first supporting layer of the first substrate are respectively disposed on the two opposite sides of the thinned first inorganic transparent plate.

The thinned substrate of the present invention includes the inorganic transparent plate and the supporting layer, wherein the supporting layer may be used for strengthening a structural strength of the whole thinned substrate, such that the structural strength of the thinned substrate may be greater than that of the inorganic transparent plate. Therefore, damage of the substrate due to poor structural strength of the substrate occurred during processing, transporting or fabricating of the thinned substrate may be mitigated, and a better production yield may be achieved.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a cross-sectional view of a thinned substrate applied in a display panel according to an embodiment of the present invention.

FIG. 2 and FIG. 3 are top views of a thinned substrate having different buffer patterns.

FIG. 4˜FIG. 7 are cross-sectional views of a thinned substrate having different buffer patterns.

FIG. 8 is a cross-sectional view of a thinned substrate used for a display panel according to an embodiment of the present invention.

FIG. 9A˜FIG. 9C are schematic diagrams illustrating different structures of a composite material layer according to an embodiment of the present invention.

FIG. 10A and FIG. 10B are diagrams illustrating a method of fabricating a display panel according to an embodiment of the present invention.

FIG. 11 is a top view of the display panel of FIG. 10B.

### DESCRIPTION OF EMBODIMENTS

A thinned substrate of the present invention may be applied to a display panel, and the display panel may be a liquid crystal display (LCD) panel such as a transmissive display panel, a semi-transmissive display panel, a reflective display panel, a color filter on array (COA) display panel, an array on color filter (AOC) display panel, a vertical alignment (VA) display panel, an in-plane-switching (IPS) display panel, a multi-domain vertical alignment (MVA) display panel, a twisted nematic (TN) display panel, a super TN (STN) display panel, a patterned vertical alignment (PVA) display panel, a super PVA (S-PVA) display panel, an advanced super view (ASV) display panel, a fringe field switching (FFS) display panel, a continuous pinwheel alignment (CPA) display panel, an axially symmetric aligned micro-cell mode (ASM) display panel, an optically compensated bend (OCB) display panel, a super IPS (S-IPS) display panel, an advanced S-IPS (AS-IPS) display panel, an ultra FFS (UFFS) display panel, a polymer stable alignment display panel, a dual-view display panel, a triple-view display panel, a three-dimensional display panel, or other types of display panels, or combinations thereof. Moreover, the display panel may also be an electro-luminescence display panel such as a fluorescence electro-luminescence display panel, a phosphorescence electro-luminescence display panel, or a combination thereof, and the electro-luminescence material of the electro-luminescence display panel includes organic material, inorganic material, or a combination thereof, and molecule of the electro-luminescence material includes small molecules, polymer, or a combination thereof.

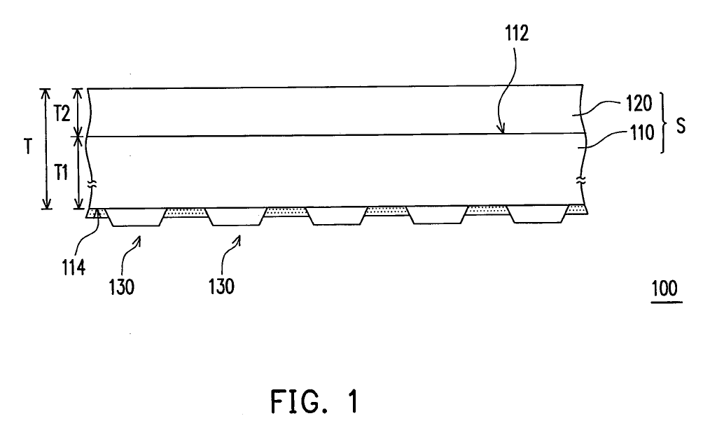

FIG. 1 is a cross-sectional view of a thinned substrate used for a display panel according to an embodiment of the present invention. Referring to FIG. 1, the thinned substrate 100 used for the display panel includes an inorganic transparent plate 110 having a surface 112 and a corresponding surface 114. Since thickness of the inorganic transparent plate 110 is relatively thin, to further improve a whole structural strength of the thinned substrate 100, a supporting layer 120 is further disposed on the surface 112 of the inorganic transparent plate 110. In the present embodiment, the supporting layer 120 and the inorganic transparent plate 110 may be connected via static electricity. In another embodiment, the supporting layer 120 and the inorganic transparent plate 110 may be connected via an adhesive layer (not shown) disposed there between.

The supporting layer 120 and the inorganic transparent plate 110 are stacked to form a stacked layer S. Moreover, in a preferred situation, such as a ratio between thickness T1 of the inorganic transparent plate 110 and the thickness T2 of the supporting layer 120 is substantially less than or substantially equal to 4, and is greater than 0. A total thickness T of the stacked layer S is substantially less than or substantially equal to 20 mm. Bending strength of the stacked layer S is substantially greater than or substantially equal to 150 MPa.

In the present embodiment, material of the inorganic transparent plate 110 includes glass, quartz, or other suitable inorganic transparent materials, or combinations thereof. In a preferred situation, the thickness of the inorganic transparent material 110 is substantially range from 0.03 mm to 15 mm, but the present invention is not limited thereto, the thickness of the inorganic transparent plate 110 may also be substantially less than 0.03 mm, for example, the thickness of the inorganic transparent plate 110 is 0.028 mm, 0.025 mm, 0.022 mm, 0.02 mm, 0.015 mm, 0.01 mm, 0.009 mm, 0.008 mm, or 0.007 mm etc., and is substantially greater than 0. The thickness of the inorganic transparent material 110 may also be substantially less than 20 mm, for example, 19.5 mm, 18 mm, 17 mm, 16 mm or 15.5 mm etc. Moreover, the transmittance of the inorganic transparent plate is substantially range of 5% to 100%, and is preferably substantially range of 50% to 100%. The bending strength of the inorganic transparent plate 110, preferably, is substantially range 50 MPa to 200 MPa, but the present invention is not limited thereto.

The material of the supporting layer 120 includes organic materials, inorganic materials, or combinations thereof. Wherein, the organic material includes nylon, polymer rubber, fluoropolymer, acryl, polycarbonate ester, polyethylene terephthalate (PET), polyetheretherrketone (PEEK), polyether, polyketone, polyglycol, polyaldehyde, polyaromatics, polyolefin, polyacetylene, polyepoxysuccinic, polynaphthenes, or other suitable materials, or combinations thereof. The inorganic material includes metal, metal alloy, ceramic material, or other inorganic materials or combinations thereof. Since the ratio between the thickness T1 of the inorganic transparent plate 110 and the thickness T2 of the supporting layer 120 is substantially less than or substantially equal to 4 mm and is substantially greater than 0, while the thickness of the inorganic transparent plate 110 is substantially range of 0.03 mm to 15 mm, and the total thickness T of the stacked layer S is substantially less than or substantially equal to 20 mm, and therefore the thickness T2 of the supporting layer 120 is substantially range of 0.01 mm to 5 mm.

Moreover, in a preferred situation, the bending strength of the supporting layer 120 is substantially range of 50 MPa to 1000 MPa, and if the material of the supporting layer 120 is organic materials, the bending strength thereof is substantially range of 50 MPa to 170 MPa. In addition, to avoid scratch on the inorganic transparent plate 110, Vicker's hardness of the supporting layer 120, preferably, is substantially less than or substantially equal to 600 kg/mm², but the present invention is not limited thereto, such factor and/or such value may also not be taken into consideration. Moreover, a ratio between area of the supporting layer 120 and area of the inorganic transparent plate 110 is substantially greater or substantially equal to 1, or substantially less than or equal to 1. In a preferred situation, the ratio between the area of the supporting layer 120 and the area of the inorganic transparent plate 110 is substantially range of 0.1 to 1.5. Wherein, if the above ratio is substantially greater than 1, the supporting layer 120 may further cover a side surface (i.e. a side surface adjacent to the surface 112 of the inorganic transparent plate 110 covered by the supporting layer 120, namely, the supporting layer may extend along a direction of the thickness T1, or further extend to the surface 114) of the inorganic transparent plate 110. Moreover, Since the supporting layer 120 may improve the whole structural strength of the thinned substrate 100, a bending strength formula of the stack layer S formed by the supporting layer 120 and the inorganic transparent plate 110 is described in detail as below. The bending strength formula 1 of the stacked layer S is as follows:

Pc=[(Σfi·Pi)]*(T/T1)² (formula 1)

Wherein Pc is the bending strength of the stacked layer S (unit: MPa), fi is a volume ratio of an i-th layer, Pi is the bending strength of the i-th layer (unit: MPa), T1 is the thickness of the substrate (i.e. the inorganic transparent plate 110) of the stacked layer S (unit: mm), and T is a total thickness of the stacked layer S (unit: mm).

In the present embodiment, assuming the thickness T1 of the inorganic transparent plate 110 and the thickness T2 of the supporting layer 120 are 0.4 mm, and the bending strengths of the inorganic transparent plate 110 and the supporting layer 120 are respectively 135 MPa and 125 MPa. If the above parameters are input to the formula 1, a calculation result is then as follow:

If f1=0.4/(0.4+0.4)=0.5, f2=0.4/(0.4+0.4)=0.5, and T1/T2 or T2/T1=1.0, then, Pc=[(0.5·135 MPa)+(0.5·125 MPa)]*((0.4+0.4)/0.4)²=520 MPa (formula 2)
Wherein f1 is the volume ratio of the inorganic transparent plate 110, and f2 is the volume ratio of the supporting layer 120.

According to the formula 2, the bending strength (520 MPa) of the stacked layer S formed by the supporting layer 120 and the inorganic transparent plate 110 is greater than the bending strength (135 MPa) of the inorganic transparent plate 110. In other words, by applying the supporting layer 120, reliability of the thinned substrate 100 may be improved, and accordingly production yield of display panels applying the thinned substrate 100 may be improved. If the thickness T1 of the inorganic transparent plate 110 and the thickness T2 of the supporting layer 120 are all 10 mm, and the bending strengths of the inorganic transparent plate 110 and the supporting layer 120 are respectively 50 MPa and 50 MPa, these parameters may input to the formula 1, and the calculation result is then as follow:

If f1=10/(10+10)=0.5, f2=10/(10+10)=0.5, and T1/T2 or T2/T1=1.0, then, Pc=[(0.5·50 MPa)+(0.5·50 MPa)]*((10+10)10)²=200 MPa (formula 3)

According to the formula 3, it is obvious that the bending strength (200 MPa) of the stacked layer S formed by the supporting layer 120 and the inorganic transparent plate 110 is greater than the bending strength (50 MPa) of the inorganic transparent plate 110.

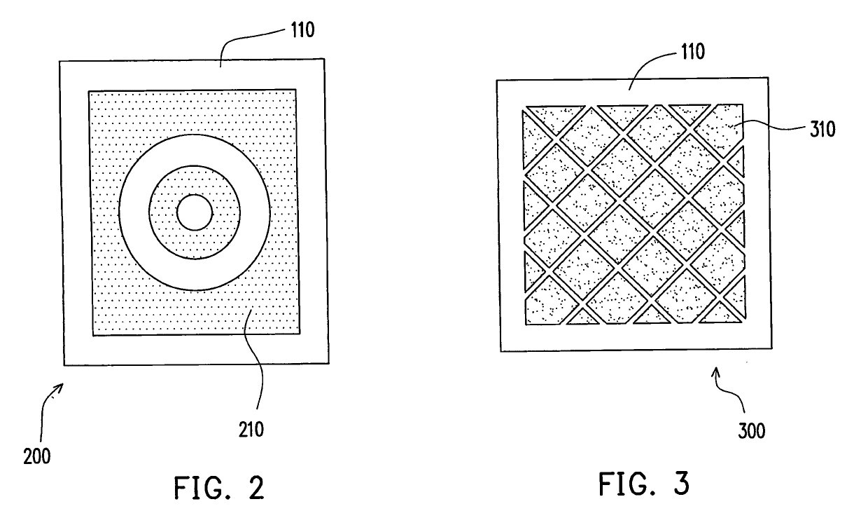

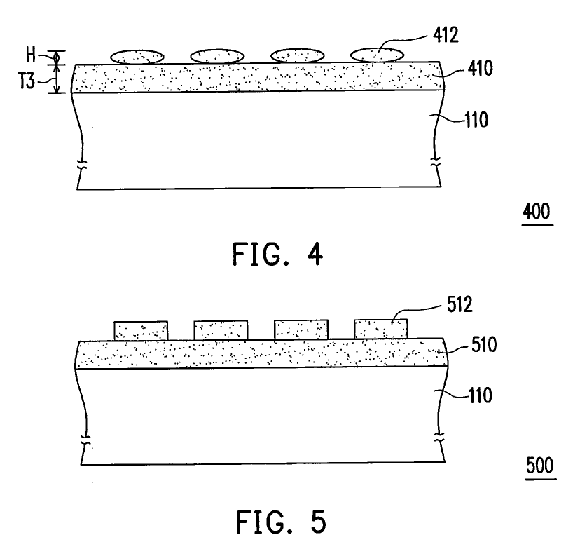

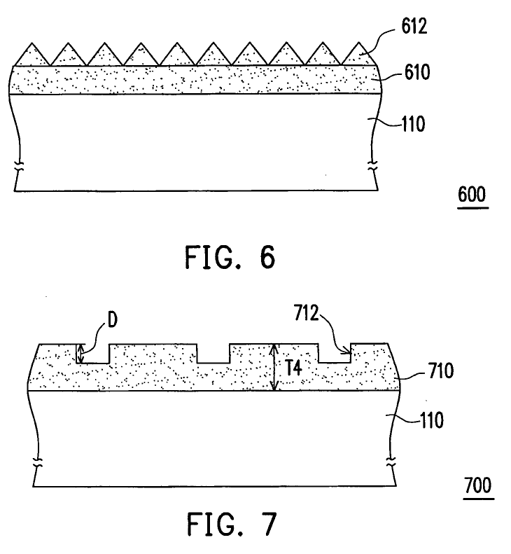

On the other hand, to further improve a buffer effect of the supporting layer under a function of external forces, a buffer pattern may further be formed on the supporting layer. Next, the plurality of different buffer patterns formed on the supporting layer is described with reference of FIG. 2˜FIG. 7. Certainly, the following descriptions are only for examples, and the present invention is not limited thereof. FIG. 2 and FIG. 3 are top views of a thinned substrate having different buffer patterns, and FIG. 4˜FIG. 7 are cross-sectional views of a thinned substrate having different buffer patterns.

Referring to FIG. 2, a supporting layer 210 of a thinned substrate 200 has a buffer pattern. The buffer pattern may be a ring-shaped pattern (for example, a plurality of concentric rings, a plurality of non-concentric rings, or other ring-shaped patterns, or combinations thereof). Moreover, referring to FIG. 3, a buffer pattern on a supporting layer 310 of a thinned substrate 300 may also be a grid-shaped pattern. Certainly, the present invention is not limited thereof, and the buffer pattern may also be a spiral-shaped pattern, or other suitable buffer patterns.

In addition, referring to FIG. 4, the buffer pattern on a supporting layer 410 of a thinned substrate 400 may includes a plurality of protrusions 412, and a cross-sectional view of the protrusions 412 are substantially ellipses shaped. Wherein, a ratio between height H of the protrusions 412 and the thickness T3 of the supporting layer 410 is preferable between 0.01 and 1, but the present invention is not limited thereof. Moreover, Referring to FIG. 5, the cross-sectional view of protrusions 512 on a supporting layer 510 of a thinned substrate 500 are substantially blocks. Referring to FIG. 6, the cross-sectional view of protrusions 612 on a supporting layer 610 of a thinned substrate 600 are substantially cones. Moreover, profile shapes of the protrusions may further include substantially semicircles, waves, pentagons, trapezoids, hexagons, or other polygons. In addition, referring to FIG. 7, a supporting layer 710 of a thinned substrate 700 may have a plurality of concaves 712, and a ratio between depth D of the concaves 712 and the thickness T4 of the supporting layer 700, preferably, is substantially range of 0.1 to 1, but the present invention is not limited thereof. Moreover, the profile shapes of the concaves 712 are substantially quadrilaterals, but the present invention is not limited thereto, and the profile shapes of the concaves 712 may also include curves, substantially circle, substantially ellipses, substantially half rhombuses, substantially triangles, substantially rectangles, substantially pentagons, substantially hexagons, or other polygons.

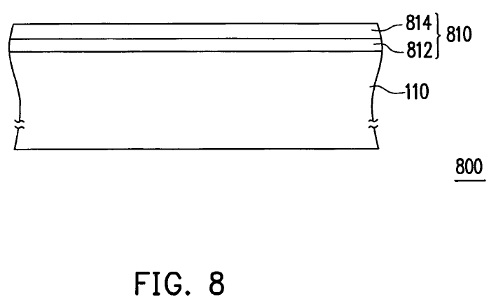

FIG. 8 is a cross-sectional view of a thinned substrate used for a display panel according to an embodiment of the present invention. Referring to FIG. 8, the thinned substrate 800 is similar to the thinned substrate 100, and the difference there between is that a supporting layer 810 of the thinned substrate 800 is a composite material layer, wherein the composite material layer includes a material layer 812 and a material layer 814. The material layer 812 is disposed between the inorganic transparent plate 110 and the material layer 814. Moreover, to prevent the supporting layer 810 damaging the inorganic transparent plate 110, Vicker's hardness of the material layer 812, preferably, is substantially less than that of the material layer 814, but the present invention is not limited thereto, and such factor may also be not taken into consideration. In the present embodiment, the material layer 812 preferably applies the organic materials, and the material layer 814 preferably applies the inorganic materials or vice versa, or the material layers 812 and 814 may apply the substantially identical material.

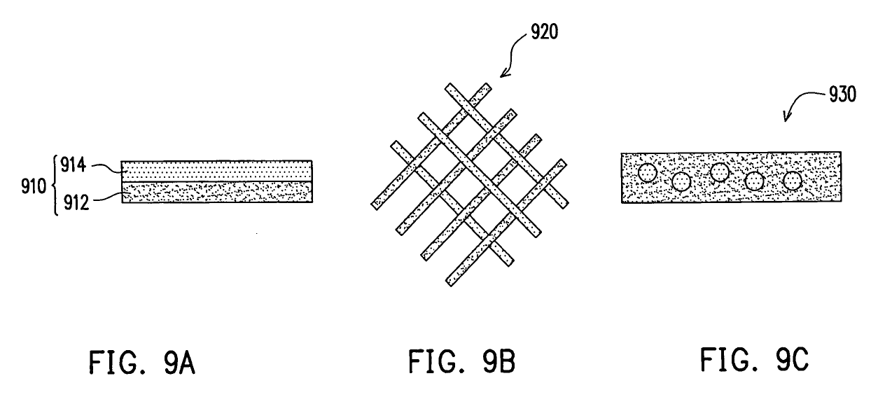

In addition, the composite material layer may also be a layer complex-layer 910 (as shown in FIG. 9A), a woven complex-layer 920 (as shown in FIG. 9B), a doping particle complex-layer 930 (as shown in FIG. 9C), or other suitable composite material layer or combinations thereof. Wherein, as shown in FIG. 9A, the layer complex-layer 910 has a first material layer 912 and a second material layer 914, and materials applied to the first material layer 912 and the second material layer 914 may be substantially identical or different, but the present invention is not limited thereto. For example, number of layers of the first material layer 912 and the second material layer 914 of the composite material layer utilized in the present invention may be adjusted according to an actual requirement. Wherein, materials of the first material layer 912 and the second material layer 914 may be organic materials, inorganic materials, or combinations thereof.

Moreover, the supporting layer 120 may be removed according to an actual requirement. For example, the supporting layer 120 may be removed when fabrication of elements on the thinned substrate 100 is completed, or when cell process or cutting process of the display panel (not shown) of the thinned substrate 100 is completed.

In addition, the inorganic transparent plate 110 includes a plurality of display devices 130 disposed on the surface 114. In the present embodiment, the inorganic transparent plate 110 may function as a substrate of color filters, and the display devices 130 on the inorganic transparent plate 110 may be the color filters. In another embodiment, the inorganic transparent plate 110 may function as an active devices array substrate, and therefore the display devices on the inorganic transparent plate may be active devices such as thin film transistors etc. Moreover, the display devices may also be combinations of the thin film transistors and the color filters, so as to form a color filter on array (COA) substrate or an array on color filter (AOC) substrate.

Base on the aforementioned embodiments, a method of manufacturing the thinned substrate 100 is provided. Referring to FIG. 1 again, first, a thinned inorganic transparent plate 110 including a plurality of display devices 130 is provided. Next, a supporting layer 120 is provided to the thinned inorganic transparent plate 110 adapted to stack with the thinned inorganic transparent plate 110 to form a stacked layer S. Wherein, the supporting layer 120 and the display devices 130 are respectively disposed at two opposite sides of the thinned inorganic transparent plate 110. Moreover, the ratio between the thickness T1 of the thinned inorganic transparent plate 110 and the thickness T2 of the supporting layer 120 is substantially less than or substantially equal to 4, and is substantially greater than 0. The total thickness of the thinned inorganic transparent plate 110 and the supporting layer 120 is substantially less than or substantially equal to 20 mm, and the bending strength of the stacked layer S is substantially greater than or substantially equal to 150 MPa. In the present embodiment, the supporting layer 120 and the inorganic transparent plate 110 may be connected via static electricity. In another embodiment, the supporting layer 120 and the inorganic transparent plate 110 may be connected via an adhesive layer (not shown) disposed there between.

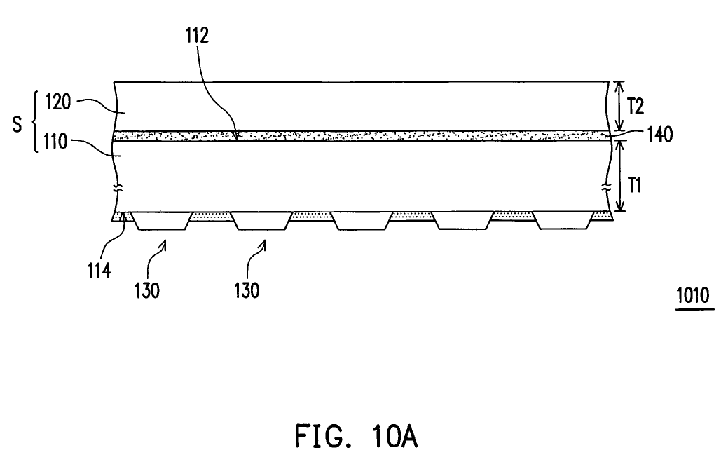

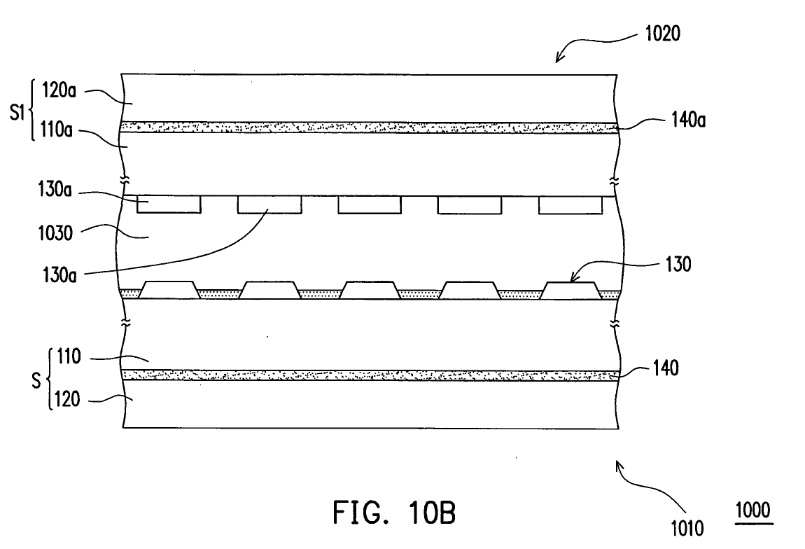

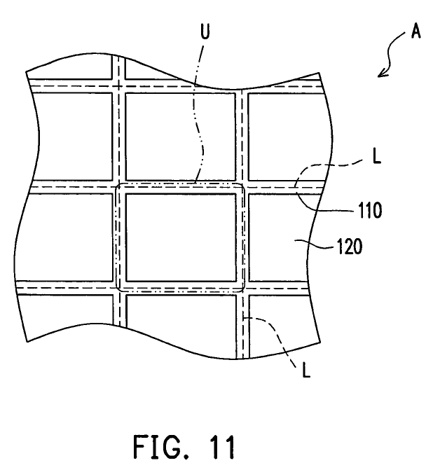

In addition, based on the aforementioned embodiment, a method of fabricating a display panel applying the aforementioned thinned substrate 100 is further provided. It should be noted that in the present embodiment, a method of fabricating a liquid crystal display panel is taken as an example, however, the present invention is not limited thereto. FIG. 10A and FIG. 10B are diagrams illustrating a method of fabricating a display panel according to an embodiment of the present invention. FIG. 11 is a top view of the display panel of FIG. 10B. First, referring to FIG. 10A, a thinned inorganic transparent plate 110 having a surface 112 and a corresponding surface 114 is provided, wherein the thinned inorganic transparent plate 110 includes a plurality of the display devices 130 disposed on the surface 114.

Next, a supporting layer 120 is provided to the surface 112 of the thinned inorganic transparent plate 110 adapted to stack with the thinned inorganic transparent plate 110 to form a stacked layer S. Wherein, the supporting layer 120 and the display devices 130 are respectively disposed at two opposite sides of the inorganic transparent plate 110. Moreover, the supporting layer 120 and the thinned inorganic transparent plate 110 may be connected via an adhesive layer 140 disposed there between. Material of the adhesive layer 140 may be light-cured adhesive, thermal-cured adhesive, or other suitable adhesives, or combinations thereof. Alternatively, the supporting layer 120 and the thinned inorganic transparent plate 110 may be connected via static electricity. Until now, fabrication of the substrate 1010 of the display panel is basically completed.

Next, referring to FIG. 10B and FIG. 11, another substrate 1020 is provided. The supporting layer 120 of the substrate 1010 and the substrate 1020 are respectively located at two opposite sides of the thinned inorganic transparent plate 110. Then, a cell process is performed to the substrate 1010 and the substrate 1020, so as to form a display panel array A composed of a plurality of display panel units U. After the cell process, the supporting layer 120 may be removed, but the present invention is not limited thereto. For example, the supporting layer 120 may be removed after the display devices 130 are formed, or may be removed according to an actual requirement.

In the present embodiment, a display media layer 1030 such as a liquid crystal layer, an electro-luminescence device layer, or combinations thereof may be formed between the substrate 1010 and the substrate 1020. Now, fabrication of the display panel 1000 of the present invention is basically completed. Moreover, the inorganic transparent plate 110 may have a plurality of pre-cutting lines L, so as to confine the plurality of the display panel units U. The display panel array A may be cut along the pre-cutting lines L between the substrates 1010 and 1020 before or after the display media layer 1030 is formed, so as to obtain the plurality of display panel units U.

Referring to FIG. 10B again, method of fabricating the substrate 1020 is as follows. First, a thinned inorganic transparent plate 110a having a plurality of display devices 130a is provided. Next, a supporting layer 120a is provided to the thinned inorganic transparent plate 110a to form a substrate 1020. The supporting layer 120a and the thinned inorganic transparent plate 110a form a stacked layer S1. The supporting layer 120a and the display devices 130a are respectively disposed at two opposite sides of the thinned inorganic transparent plate 110a, and the supporting layer 120a and the substrate 1010 are respectively disposed at the two opposite sides of the thinned inorganic transparent plate 110a. In the present embodiment, the supporting layer 120a may be attached to the thinned inorganic transparent plate 110a via an adhesive layer 140a. Wherein, material of the adhesive layer 140a may be light-cured adhesive, thermal-cured adhesive, or other suitable adhesives, or combinations thereof. Alternatively, in another embodiment, the supporting layer 120a and the thinned inorganic transparent plate 110a may also be connected via the static electricity.

It should be noted that the substrate 1010 is similar to the substrate 1020, and the difference there between is that the substrate 1010 may function as the color filters, and the display devices 130 on the inorganic transparent plate 110 may be the color filter units. Now, the substrate 1020 may function as the active devices array substrate, and the display devices 130a may be the thin film transistors. In another embodiment, the substrate 1010 may be the COA substrate or the AOC substrate, the display devices 130 may be combinations of the color filter units and the thin film transistors, and the display devices 130a on the substrate 1020 may be a common electrode. Moreover, in the aforementioned fabrication method, the substrates 1010 and 1020 having the plurality of the display units U are taken as an example, and the substrates 1010 and 1020 are referred to as mother substrates. A plurality independent display panels may be formed by cutting the mother substrates, and the display panels on the mother substrates may be referred to as half-finished or unfinished panels, and the independent display panels are referred to as finished panels. In other words, the supporting layers 120 and 120a may be applied to the half-finished panels, the unfinished panels, or the finished panels.

In summary, the thinned substrate of the present invention includes an inorganic transparent plate and a supporting layer. The supporting layer avails improvement of the whole structural strength of the thinned substrate, so as to improve the reliability of the thinned substrate. Therefore, the thinned substrate of the present invention may bear more impact of external forces occurred during transporting, processing, or fabricating of the thinned substrate, and therefore production yield of the display panels applying the thinned substrate of the present invention may be improved.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A thinned substrate for a display panel, comprising:
an inorganic transparent plate; and
a supporting layer stacked with the inorganic transparent plate to form a stacked layer, wherein a ratio between thickness of the inorganic transparent plate and thickness of the supporting layer is substantially less than or substantially equal to 4, and is substantially greater than 0, a total thickness of the staked layer is substantially less than or substantially equal to 20 mm, and bending strength thereof is substantially greater than or substantially equal to 150 MPa.

2. The thinned substrate of claim 1, further comprising a plurality of display devices disposed on the stacked layer.

3. The thinned substrate of claim 1, wherein material of the supporting layer comprises organic materials, inorganic materials, or combinations thereof.

4. The thinned substrate of claim 1, wherein the thickness of the inorganic transparent plate is substantially between 0.03 mm and 15 mm.

5. The thinned substrate of claim 1, wherein the thickness of the supporting layer is substantially between 0.01 mm and 5 mm.

6. The thinned substrate of claim 1, wherein a bending strength of the inorganic transparent plate substantially ranges of 50 MPa to 200 MPa.

7. The thinned substrate of claim 1, wherein a bending strength of the supporting layer substantially ranges of 50 MPa to 1000 MPa.

8. The thinned substrate of claim 1, wherein a Vicker's hardness of the supporting layer is substantially less than or substantially equal to 600 kg/mm².

9. The thinned substrate of claim 1, wherein the supporting layer is a composite material layer.

10. The thinned substrate of claim 9, wherein the composite material layer comprises a layer complex-layer, a woven complex-layer, or a doping particle complex-layer.

11. The thinned substrate of claim 9, wherein the composite material layer comprises a first material layer and a second material layer, the first material layer is located between the inorganic transparent plate and the second material layer, and a Vicker's hardness of the first material layer is substantially less than that of the second material layer.

12. The thinned substrate of claim 1, wherein the supporting layer has a buffer pattern.

13. The thinned substrate of claim 12, wherein the buffer pattern is a ring-shape pattern, a grid-shape pattern, or combinations thereof.

14. The thinned substrate of claim 12, wherein the buffer pattern comprises a plurality of protrusions, a plurality of concaves, or combinations thereof.

15. The thinned substrate of claim 14, wherein the protrusions comprise ellipse-shaped protrusions, block-shaped protrusions, cone-shaped protrusions, or combinations thereof.

16. The thinned substrate of claim 14, wherein a ratio between height of each protrusion and thickness of the supporting layer substantially ranges of 0.01 to 1.

17. The thinned substrate of claim 14, wherein a ratio between depth of each concave and thickness of the supporting layer substantially ranges of 0.01 to 1.

18. The thinned substrate of claim 1, wherein a ratio between area of the supporting layer and area of the inorganic transparent plate substantially ranges of 0.1 to 1.5.

19. The thinned substrate of claim 1, wherein the supporting layer and the inorganic transparent plate are connected via static electricity.

20. The thinned substrate of claim 1, further comprising an adhesive layer disposed between the supporting layer and the inorganic transparent plate.

21. A method for fabricating a substrate of a display panel, the method comprising:
providing a thinned inorganic transparent plate comprising a plurality of display devices; and
providing a supporting layer to the thinned inorganic transparent plate adapted to stack with the thinned inorganic transparent plate to form a stacked layer, wherein the supporting layer and the display devices are respectively disposed at two opposite sides of the inorganic transparent plate, and a ratio between thickness of the thinned inorganic transparent plate and thickness of the supporting layer is substantially less than or substantially equal to 4, and is substantially greater than 0, a total thickness of the thinned inorganic transparent plate and the supporting layer is substantially less than or substantially equal to 20 mm, and bending strength of the stacked layer is substantially greater than or substantially equal to 150 MPa.

22. The method of claim 21, wherein the supporting layer and the inorganic thinned transparent plate are connected via static electricity.

23. The method of claim 21, wherein the supporting layer is attached to the thinned inorganic transparent plate via an adhesive layer.
